(19) United States
(12) Patent Application Publication
(10) Pub. No.: US 2017/0026924 A1
(43) Pub. Date: Jan. 26, 2017

(54) AIR INTERFACE SYNCHRONIZATION METHOD AND SYSTEM

(71) Applicant: ZTE Corporation, Shenzhen, Guangdong (CN)

(72) Inventors: Wei Gou, Shenzhen (CN); Yajun Zhao, Shenzhen (CN); Xiaogang Han, Shenzhen (CN); Feng Xie, Shenzhen (CN)

(21) Appl. No.: 15/124,420

(22) PCT Filed: Dec. 25, 2014
(86) PCT No.: PCT/CN2014/095017

§ 371 Date: Sep. 8, 2016

(30) Foreign Application Priority Data
Mar. 11, 2014 (CN) 201410088825.3

(51) Int. Cl. H04W 56/00; H04W 72/04

(52) U.S. Cl. CPC H04W 56/0015; H04W 72/0446

(57) ABSTRACT

An air interface synchronization method and a system are disclosed in the present invention. The method includes: a base station in a target cell sends request information for intercepting to a center node, and the request information carries the information about a candidate source cell; the center node determines air interface synchronization interception relation, sends source cell determination information and location information of intercepted sub-frame of the RS to a base station in the source cell, and sends intercepted source cell determination information and location information of intercepted sub-frame to the base station in the target cell.

### TECHNICAL FIELD

The disclosure relates to the field of wireless communication, and in particular to an air interface synchronization method and system.

### BACKGROUND

In Long Term Evolution (LTE), a synchronization solution for a small cell and a macro cell is currently studied, the synchronization solution may be configured for synchronization between small cells (as well as other scenarios, including cell synchronization between different operators). The small cell receives a Reference Signal (RS) for air interface synchronization from the macro cell, and then calculates a time deviation with the macro cell to calibrate time, fulfilling the aim of synchronization with the macro cell.

At present, a Multicast/Broadcast Single Frequency Network (MBSFN)-subframe-based manner has been determined as a basis for air interface synchronization. A basic principle of the MBSFN-subframe-based manner is as follows.

A small cell implements synchronization with the macro cell through monitoring a Cell-specific Reference Signal (CRS) sent by a macro cell, and the small cell configures own subframe (monitoring subframe) of the CRS received from the macro cell into an MBSFN subframe and sends the MBSFN subframe to subordinate User Equipment (UE). In such a manner, influence on transmission, measurement and the like of a Physical Downlink Shared Channel (PDSCH) of the subordinate UE of the small cell may be minimized.

Under a small cell deployment, particularly under a high-density small cell deployment, many small cells required to execute monitoring may usually not directly receive RSs for air interface synchronization from a macro cell, but are required to receive RSs for air interface synchronization from adjacent small cells, which are taken as source cells, to implement synchronization with the small cells; and however, since there exists a certain time difference between a small cell and a macro cell and particularly a source cell under a multi-hop condition may have a greater time difference with the macro cell, some companies suggest introduction of a parameter: layer number, configured to describe a synchronization level of the source cell. For example, if it is specified that a layer number of a macro cell that serves as a source cell is 0, small cell 1 directly receives an RS for air interface synchronization from the macro cell for synchronization with the macro cell. Furthermore, when small cell 1 serves as a source cell of small cell 2, a layer number of small cell 1 is 1; when small cell 2 serves as a source cell of small cell 3, a layer number of small cell 2 is 2; and so on. It is considered that there are no time differences between source cells of the same layer.

Small cells are usually deployed in a high-density manner, thus the concept of small cell cluster is introduced to facilitate management. Subordinate small cells of the same macro cell belong to different small cell clusters according to geographical positions respectively. There may also exist certain interference among the small cell clusters, and the small cells are required to avoid a different small cell cluster when selecting source cells.

However, an existing air interface synchronization process has some problems.

The existing process is as follows: a target cell sends an air interface synchronization request containing cell information of a source cell to a core network; then the core network interacts with the source cell to acquire layer information and synchronization state information of the source cell, and then sends the layer information and synchronization state information of the source cell to the target cell; the target cell independently determines whether to select the source cell as its own source cell, and the process is ended.

Obviously, in the existing process, the source cell does not know whether it is finally selected by a certain target cell as a source cell. Furthermore, according to the latest discussion about LTE air interface synchronization enhancement, the source cell is still required to send a listening RS when being off, and then according to the existing process, since the source cell does not know whether it is selected as the source cell, the source cell may not correctly determine whether to still send the listening RS when being off.

### SUMMARY

In order to solve the existing technical problem, the disclosure is intended to provide an air interface synchronization method and system, so as to implement air interface synchronization between cells.

The technical solutions of the disclosure are implemented as follows.

The disclosure provides an air interface synchronization method, which may include that:

a target cell Evolved Node B (eNB) sends listening request information containing candidate source cell information to a central node; and

the central node determines an air interface synchronization monitoring relationship according to the candidate source cell information, sends source cell determination information and listening RS subframe position information to a source cell eNB determined according to the air interface synchronization monitoring relationship, and sends listening source cell information and the listening RS subframe position information to the target cell eNB.

The disclosure provides an air interface synchronization method, which may include that:

a target cell eNB sends listening request information for air interface synchronization to candidate source cell eNBs;

the candidate source cell eNBs receive the listening request information, and send request responses to the target cell eNB; and

the target cell eNB selects a source cell eNB according to the request responses, wherein the request responses may include one or more of: listening RS subframe position information, layer numbers and RS configuration information.

The disclosure provides an air interface synchronization method, which may include that:

a target cell eNB sends listening request information containing candidate source cell information to a central node;

the central node acquires related information of candidate source cells, and sends the related information to the target cell eNB; and

the target cell eNB selects a source cell eNB according to the related information,

wherein the related information may include one or more of: listening RS subframe position information, a layer number and RS configuration information.

The disclosure provides an air interface synchronization method, which may include that:

a target cell eNB sends listening request information containing candidate source cell information to a central node;

the central node acquires related information of candidate source cells, and sends the related information to the target cell eNB; and

the target cell eNB selects a source cell eNB according to the related information,

wherein the related information may include one or more of: listening RS subframe position information, a layer number and RS configuration information.

The disclosure provides an air interface synchronization method, which may include that:

a target cell eNB selects a source cell eNB, and sends source cell determination information and listening RS subframe position information to the selected source cell eNB; and

the source cell eNB sends a listening RS at a listening RS subframe position according to the listening RS subframe position information.

The disclosure provides an air interface synchronization method, which may include that:

a central node sends source cell determination information and listening RS subframe position information to a source cell eNB of a cell selected as a source cell; and

the source cell eNB sends a listening RS at a listening RS subframe position according to the listening RS subframe position information.

The disclosure provides an air interface synchronization method, which may include that:

a target cell eNB obtains a listening RS subframe position, sends listening RS subframe position information to an adjacent cell eNB, and indicates the adjacent cell eNB to execute muting at the listening RS subframe position.

The disclosure provides an air interface synchronization method, which may include that:

a central node determines a listening RS subframe position of a target cell, and sends listening RS subframe position information to a target cell eNB; and

the target cell eNB sends the listening RS subframe position information to an adjacent cell eNB of the target cell eNB.

The disclosure provides an air interface synchronization method, which may include that:

a central node determines a listening RS subframe position of a target cell, sends listening RS subframe position information to a target cell eNB and an adjacent cell eNB of the target cell eNB, and indicates the adjacent cell eNB of the target cell eNB to execute muting at the listening RS subframe position.

The disclosure provides an air interface synchronization method, which may include that:

a target cell eNB selects a source cell eNB, and sends source cell determination information containing listening RS subframe position information to the selected source cell eNB;

the source cell eNB receives the source cell determination information, and sends the listening RS subframe position information to own adjacent cell eNB; and

the adjacent cell eNB executes muting at a listening RS subframe position according to the listening RS subframe position information.

The disclosure provides an air interface synchronization method, which may include that:

a target cell eNB sends listening RS subframe position information to an adjacent cell eNB belonging to the same operator, and indicates the adjacent cell eNB belonging to the same operator to execute muting at a listening RS subframe position.

The disclosure provides an air interface synchronization system, which may include: a target cell eNB, a central node and a source cell eNB, wherein

the target cell eNB may be configured to send listening request information containing candidate source cell information to the central node, and receive listening source cell information and listening RS subframe position information;

the central node may be configured to determine an air interface synchronization monitoring relationship according to the candidate source cell information, send source cell determination information and the listening RS subframe position information to the source cell eNB determined according to the air interface synchronization monitoring relationship, and send the listening source cell information and the listening RS subframe position information to the target cell eNB; and

the source cell eNB may be configured to receive the source cell determination information and the listening RS subframe position information.

The disclosure provides an air interface synchronization system, which may include: a target cell eNB and candidate source cell eNBs, wherein

the target cell eNB may be configured to send listening request information for air interface synchronization to the candidate source cell eNBs, and select a source cell eNB according to request responses of the candidate source cell eNBs; and

the candidate source cell eNBs may be configured to receive the listening request information and send the request responses to the target cell eNB, wherein the request responses may include one or more of: listening RS subframe position information, layer numbers and RS configuration information.

The disclosure provides an air interface synchronization system, which may include: a target cell eNB, a central node and a source cell eNB, wherein

the target cell eNB may be configured to send listening request information containing candidate source cell information to the central node, and select the source cell eNB according to related information, sent by the central node, of candidate source cells; and

the central node may be configured to acquire the related information of the candidate source cells, and send the related information to the target cell eNB, wherein the related information may include one or more of: listening RS subframe position information, a layer number and RS configuration information.

The disclosure provides an air interface synchronization system, which may include: a target cell eNB, a central node and a source cell eNB, wherein

the target cell eNB may be configured to send listening request information containing candidate source cell information to the central node, and select the source cell eNB according to related information, sent by the central node, of candidate source cells; and

the central node may be configured to acquire the related information of the candidate source cells, and send the related information to the target cell eNB,

wherein the related information may include one or more of: listening RS subframe position information, a layer number and RS configuration information.

The disclosure provides an air interface synchronization system, which may include: a target cell eNB and a source cell eNB, wherein

the target cell eNB may be configured to select the source cell eNB, and send source cell determination information and listening RS subframe position information to the selected source cell eNB; and

the source cell eNB may be configured to send a listening RS at a listening RS subframe position.

The disclosure provides an air interface synchronization system, which may include: a central node and a source cell eNB, wherein

the central node may be configured to send source cell determination information and listening RS subframe position information to the source cell eNB of a cell selected as a source cell; and

the source cell eNB may be configured to send a listening RS at a listening RS subframe position according to the listening RS subframe position information.

The disclosure provides an air interface synchronization system, which may include: a target cell eNB and an adjacent cell eNB, wherein

the target cell eNB may be configured to obtain a listening RS subframe position, send listening RS subframe position information to the adjacent cell eNB, and indicate the adjacent cell eNB to execute muting at the listening RS subframe position.

The disclosure provides an air interface synchronization system, which may include: a central node, a target cell eNB and an adjacent cell eNB of the target cell eNB, wherein

the central node may be configured to determine a listening RS subframe position of a target cell, and send listening RS subframe position information to the target cell eNB;

the target cell eNB may be configured to send the listening RS subframe position information to the adjacent cell eNB of the target cell eNB; and

the adjacent cell eNB of the target cell eNB may be configured to receive the listening RS subframe position information.

The disclosure provides an air interface synchronization system, which may include: a central node, a target cell eNB and an adjacent cell eNB of the target cell eNB, wherein

the central node may be configured to determine a listening RS subframe position of a target cell, send listening RS subframe position information to the target cell eNB and the adjacent cell eNB of the target cell eNB, and indicate the adjacent cell eNB of the target cell eNB to execute muting at the listening RS subframe position;

the target cell eNB may be configured to receive the listening RS subframe position information; and

the adjacent cell eNB of the target cell eNB may be configured to receive the listening RS subframe position information and the indication.

The disclosure provides an air interface synchronization system, which may include: a target cell eNB, a source cell eNB and an adjacent cell eNB of the source cell eNB, wherein

the target cell eNB may be configured to select the source cell eNB, and send source cell determination information containing listening RS subframe position information to the selected source cell eNB;

the source cell eNB may be configured to receive the source cell determination information, and send the listening RS subframe position information to own adjacent cell eNB; and

the adjacent cell eNB of the source cell eNB may be configured to execute muting at a listening RS subframe position according to the listening RS subframe position information.

The disclosure provides an air interface synchronization system, which may include: a target cell eNB and an adjacent cell eNB belonging to the same operator, wherein

the target cell eNB may be configured to send listening RS subframe position information to the adjacent cell eNB belonging to the same operator, and indicate the adjacent cell eNB belonging to the same operator to execute muting at a listening RS subframe position; and

the adjacent cell eNB belonging to the same operator may be configured to receive the listening RS subframe position information and the indication.

According to the air interface synchronization method and system of the embodiments of the disclosure, a source cell may timely learn about whether it is selected as the source cell, so that the source cell may correctly send a listening RS when being off, and thus it is possible to avoid the problem in the existing process that the source cell which may not learn about whether it is selected as the source cell by another cell may not determine whether to continue sending the listening RS when being off.

### BRIEF DESCRIPTION OF THE DRAWINGS

FIG. 1 is a flowchart of a first air interface synchronization method according to an embodiment of the disclosure;

FIG. 2 is a flowchart of a second air interface synchronization method according to an embodiment of the disclosure;

FIG. 3 is a flowchart of a third air interface synchronization method according to an embodiment of the disclosure;

FIG. 4 is a flowchart of a fourth air interface synchronization method according to an embodiment of the disclosure;

FIG. 5 is a structure diagram of first, third and fourth air interface synchronization systems according to an embodiment of the disclosure;

FIG. 6 is a structure diagram of a second air interface synchronization system according to an embodiment of the disclosure;

FIG. 7 is a structure diagram of a fifth air interface synchronization system according to an embodiment of the disclosure;

FIG. 8 is a structure diagram of a sixth air interface synchronization system according to an embodiment of the disclosure;

FIG. 9 is a structure diagram of a seventh air interface synchronization system according to an embodiment of the disclosure;

FIG. 10 is a structure diagram of eighth and ninth air interface synchronization systems according to an embodiment of the disclosure;

FIG. 11 is a structure diagram of a tenth air interface synchronization system according to an embodiment of the disclosure; and

FIG. 12 is a structure diagram of an eleventh air interface synchronization system according to an embodiment of the disclosure.

### DETAILED DESCRIPTION

According to an air interface synchronization method of the embodiment of the disclosure, the problem which may not be solved in an existing process described in the background may be improved, and in addition, existing cell air interface synchronization development in LTE is combined to further enhance signalling transmission in the process in the disclosure, thereby enabling air interface synchronization to support muting coordination and solve related problems caused by introduction of a small cell on/off technology.

In an air interface synchronization method provided by the embodiment of the disclosure, at least the following parameters are used:

listening RS subframe position information, source cell determination information, RS configuration information, a layer number, listening request information and candidate source cell information.

Wherein, the parameters have meanings as follows:

the listening RS subframe position information: describing subframe positions for RS sending, RS monitoring and muting for a source cell, a target cell and an adjacent cell respectively;

the source cell determination information: notifying a cell that it is selected as a source cell;

the RS configuration information: describing a type and configuration information of a listening RS sent by a source cell or received by a target cell, such as a port number and a port sequence number;

the layer number: describing a layer number of a source cell;

the listening request information: sent by a target cell and indicating that the target cell is required to seek for a proper source cell, or indicating that the target cell does not require a source cell any longer and the source ell may be cancelled for the target cell; and

the candidate source cell information: sent by a target cell and describing cell information of a source cell which may serve as a source cell of the target cell.

For specific signalling design of the parameters, the disclosure provides specific examples as follows.

The source cell determination information: described by setting a bit, for example: when a value of the bit is 1, it is indicated that a cell which receives the source cell determination information is selected as a source cell; when the value of the bit is 0 or the bit is not configured, it is indicated that the cell which receives the source cell determination information is not selected as the source cell.

The listening RS subframe position information: described through period information of a listening RS subframe and starting subframe position information of the listening RS subframe, for example: the period information is P (for example, 10 seconds or 5 seconds) and a starting subframe position is subframe M (a value of M is a positive integer of 0˜9) in radio frame N (N is valued to be a positive integer of 0˜1,023, and in order to reduce signalling overhead, a value range of N may further be defined to be narrower, such as a positive integer of 0˜7). Specifically, the period information includes 1 bit which is valued to be 1 to indicate that a period is 10s and valued to be 0 to indicate that the period is 5s, the radio frame includes 3 bits of which values correspond to 0˜7 respectively, and the subframe includes 4 bits of which values correspond to 0˜9 from small to large with other states kept unused.

The RS configuration information: usually including a CRS, a Channel State Information Reference Signal (CSI-RS) and a Positioning Reference Signal (PRS), wherein it is also necessary to determine a required bit number according to the port number of an RS since the port numbers of different RSs are different.

The listening request information: described by setting a bit, for example: when a value of the bit is 1, it is indicated that a cell which sends the listening request information is required to select a suitable source cell; and when the value of the bit is 0 or the bit is not configured, it is indicated that the cell which sends the listening request information cancels an original source cell.

The candidate source cell information: which may be described through a cell physical Identifier (ID), or, which is described through a listening RS type and an RS sequence index.

Since the existing process is different from a process of the disclosure, it is impossible to completely multiplex a message of the existing process, and it is possible to set a corresponding message for a process corresponding to each manner and set information units in the messages according to the number of parameters required to be transmitted in the processes, each parameter corresponding to an information unit.

The parameters may also be added to an existing message of an X2 interface or an S1 interface for implementation.

These parameters are used for corresponding methods, and specific air interface synchronization methods will be described below.

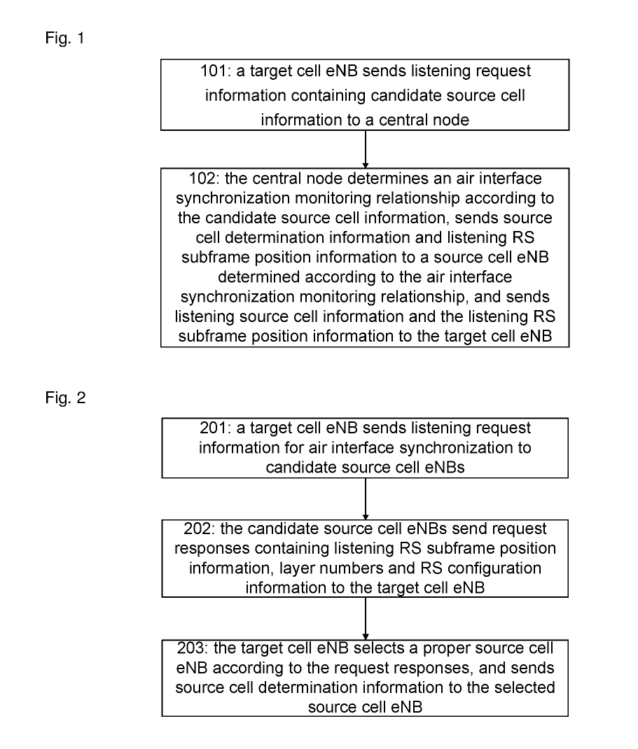

Method 1: an air interface synchronization method, as shown in FIG. 1, mainly includes the following steps:

Step 101: a target cell eNB sends listening request information containing candidate source cell information to a central node; and

Step 102: the central node determines an air interface synchronization monitoring relationship according to the candidate source cell information, sends source cell determination information and listening RS subframe position information to a source cell eNB determined according to the air interface synchronization monitoring relationship, and sends listening source cell information and the listening RS subframe position information to the target cell eNB.

In the process, the following parameters are included: the listening RS subframe position information, the candidate source cell information, the source cell determination information and the listening request information.

Method 2: an air interface synchronization method, as shown in FIG. 2, mainly includes the following steps:

Step 201: a target cell eNB sends listening request information for air interface synchronization to candidate source cell eNBs;

Step 202: the candidate source cell eNBs send request responses containing listening RS subframe position information, layer numbers and RS configuration information to the target cell eNB; and

Step 203: the target cell eNB selects a proper source cell eNB according to the request responses, and sends source cell determination information to the selected source cell eNB.

In the method, the following parameters are included: the listening RS subframe position information, the source cell determination information, the layer number, the RS configuration information and the listening request information.

Wherein, the target cell eNB may obtain information of own candidate source cells by measurement (such as Radio Resource Management (RRM) measurement). The information included in the request responses may practically be one or more of the RS subframe position information, the layer number and the RS configuration information.

Wherein, the target cell eNB selects the proper source cell eNB according to the request responses, and then may also not send the source cell determination information to the selected source cell eNB, and at this time, the source cell eNB which sends the request response defaults that it has been selected as a source cell eNB of a certain cell eNB. That is, the source cell determination information may optionally not be send to a selected source cell, which may be applicable to all related methods of the disclosure. For example, Step 203 in method 2 may be as follows: the target cell eNB selects a proper source cell eNB according to the request responses.

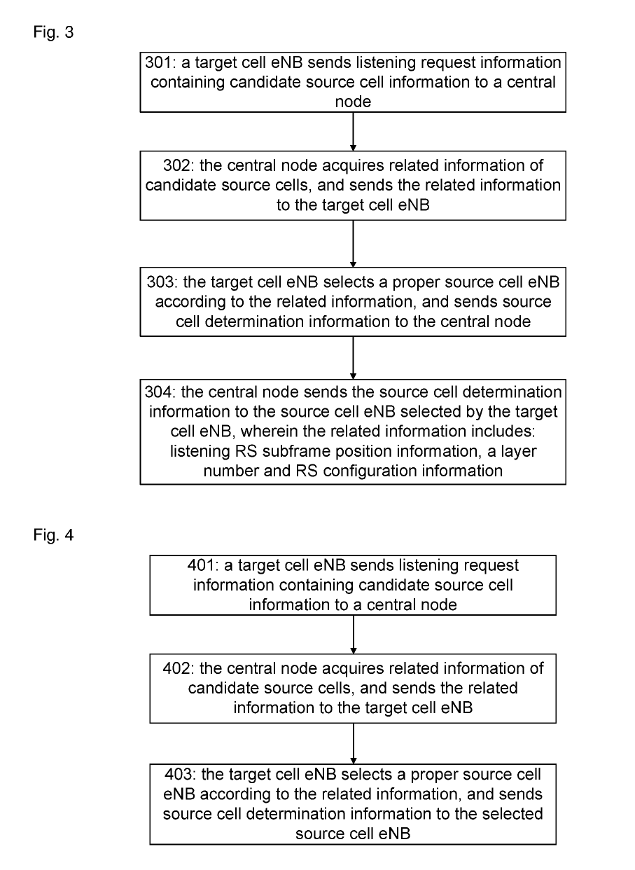

Method 3: an air interface synchronization method, as shown in FIG. 3, mainly includes the following steps:

Step 301: a target cell eNB sends listening request information containing candidate source cell information to a central node;

Step 302: the central node acquires related information of candidate source cells, and sends the related information to the target cell eNB;

Step 303: the target cell eNB selects a proper source cell eNB according to the related information, and sends source cell determination information to the central node; and

Step 304: the central node sends the source cell determination information to the source cell eNB selected by the target cell eNB, wherein the related information includes: listening RS subframe position information, a layer number and RS configuration information.

In the method, the following parameters are included: the listening RS subframe position information, the source cell determination information, the layer number, the RS configuration information, the listening request information and the candidate source cell information.

Here, Step 303 may also be as follows: the target cell eNB selects a proper source cell eNB according to the related information.

Method 4: an air interface synchronization method, as shown in FIG. 4, mainly includes the following steps:

Step 401: a target cell eNB sends listening request information containing candidate source cell information to a central node;

Step 402: the central node acquires related information of candidate source cells, and sends the related information to the target cell eNB; and

Step 403: the target cell eNB selects a proper source cell eNB according to the related information, and sends source cell determination information to the selected source cell eNB,

wherein the related information includes: listening RS subframe position information, a layer number and RS configuration information.

In the method, the following parameters are included: the listening RS subframe position information, the source cell determination information, the layer number, the RS configuration information, the listening request information and the candidate source cell information.

Here, Step 403 may also be as follows: the target cell eNB selects a proper source cell eNB according to the related information.

Method 5: an air interface synchronization method includes that:

a target cell eNB selects a proper source cell eNB, sends source cell determination information to the selected source cell eNB, and sends listening RS subframe position information determined by the target cell eNB; and the source cell eNB sends a listening RS at a listening RS subframe position, wherein the step that the target cell eNB sends the source cell determination information to the selected source cell eNB is optional.

Here, when the source cell eNB is required to be off, it is necessary to send the listening RS at the listening RS subframe position.

In addition, the source cell eNB may also send the listening RS subframe position to an adjacent cell eNB and indicate the adjacent cell eNB to execute muting at the listening RS subframe position.

In the method, the following parameters are included: the source cell determination information and the listening RS subframe position information.

Method 6: an air interface synchronization method includes that:

a central node may coordinate to send source cell determination information to a source cell eNB of a cell selected as a source cell, and simultaneously sends listening RS subframe position information; and the source cell eNB sends a listening RS at a listening RS subframe position, wherein the step that the central node simultaneously sends the listening RS subframe position information is optional.

Here, when the source cell eNB is required to be off, it is necessary to send the listening RS at the listening RS subframe position.

In the method, the following parameters are included: the source cell determination information and the listening RS subframe position information.

Method 7: an air interface synchronization method includes that:

a target cell eNB obtains a listening RS subframe position, notifies listening RS subframe position information to an adjacent cell eNB, and indicates the adjacent cell eNB to execute muting at the listening RS subframe position.

The adjacent cell eNB receives the listening RS subframe position information and the indication, and then the adjacent cell eNB may immediately execute muting at the listening RS subframe position, and may also determine whether to execute muting at the listening RS subframe position according to own condition.

The indication may be identification information or a command message, for example: identification information 1 or 0 indicates execution of muting, or command message muting indicates execution of muting.

In the method, the following parameter is included: the listening RS subframe position information; the listening RS subframe position information is described through period information of a listening RS subframe and starting subframe position information of the listening RS subframe, the listening RS subframe position information is a subframe position where the target cell eNB monitors (receives) an RS, and the target cell eNB implements air interface synchronization by virtue of the RS in the subframe; and

interaction between the target cell eNB and the adjacent cell eNB of a target cell may be implemented through an S1 interface, or an X2 interface, a wireless air interface or a backhaul link.

The step that the target cell eNB obtains the listening RS subframe position is implemented as follows:

the target cell eNB receives the listening RS subframe position sent by a central node or request responses which are sent by candidate source cell eNBs and contain the listening RS subframe position information, layer numbers and RS configuration information, or monitors RSs of candidate source cells to determine the listening RS subframe position information.

wherein, the step that the target cell eNB sends the listening RS subframe position information to the adjacent cell eNB and indicates the adjacent cell eNB to execute muting at the listening RS subframe position is implemented as follows: the listening RS subframe position information is sent to the adjacent cell eNB through the S1 interface, or the X2 interface, or the wireless air interface or the backhaul link, and the adjacent cell eNB is indicated, through the identification information or the command message, to execute muting at the listening RS subframe position.

Wherein, interaction about the identification information or the command message is also implemented through the S1 interface, or the X2 interface, or the wireless air interface or the backhaul link.

Method 8: an air interface synchronization method includes that:

a central node determines a listening RS subframe position of a target cell, and sends listening RS subframe position information to a target cell eNB; and

the target cell eNB sends the listening RS subframe position information to an adjacent cell eNB of the target cell eNB.

Method 9: an air interface synchronization method includes that:

a central node may coordinate to determine and notify a listening RS subframe position of a target cell eNB to the target cell eNB, and the central node simultaneously notifies an adjacent cell eNB of the target cell eNB to execute muting at the listening RS subframe position.

In the method, the following parameter is included: listening RS subframe position information.

Method 10: an air interface synchronization method includes that:

a target cell eNB selects a proper source cell eNB, and sends source cell determination information to the selected source cell eNB; the source cell eNB notifies listening RS subframe position information to an adjacent cell eNB; and the adjacent cell eNB executes muting at a listening RS subframe position, wherein the step that the target cell eNB sends the source cell determination information to the selected source cell eNB is optional.

In the method, the following parameters are included: the listening RS subframe position information and the source cell determination information. Referring to descriptions in Method 2, after a proper source cell is selected for a target cell, the source cell determination information may also not be sent to the selected source cell eNB.

Method 11: an air interface synchronization method includes that:

a target cell eNB sends listening RS subframe position information to an adjacent cell eNB belonging to the same operator, and indicates the adjacent cell eNB belonging to the same operator to execute muting at a listening RS subframe position.

The adjacent cell eNB receives the listening RS subframe position information and the indication, and then the adjacent cell eNB may immediately execute muting at a listening RS subframe position, and may also determine whether to execute muting at the listening RS subframe position according to own condition.

The indication may be identification information or a command message, for example: identification information 1 or 0 indicates execution of muting, or command message muting indicates execution of muting.

In the method, the following parameter is included: the listening RS subframe position information, the listening RS subframe position information is described through period information of a listening RS subframe and starting subframe position information of the listening RS subframe, and the listening RS subframe position information is a subframe position where the target cell eNB monitors an RS; and

interaction between the target cell eNB and the adjacent cell eNB of a target cell may be implemented through an S1 interface, or an X2 interface, a wireless air interface or a backhaul link.

All of the abovementioned 11 methods may optionally include that:

when the target cell eNB, or the source cell eNB or the monitoring relationship configured by the central node changes and influences air interface synchronization, for example, the target cell eNB may not correctly monitor a listening RS of a specified source cell, or the source cell eNB may not send a listening RS according to a specified listening RS subframe position, or the central node updates the monitoring relationship, a configuration relationship and a muting relationship, such changes may influence air interface synchronization, so that the target cell eNB, the source cell eNB and the central node are required to interact about such changes and timely notify an adjacent cell to timely regulate the related monitoring relationship, configuration relationship and muting relationship.

When the source cell eNB may not send the listening RS according to the specified listening RS subframe position, the source cell eNB is also required to timely notify the adjacent cell eNB, for example: the source cell eNB sends a new listening RS subframe position to the adjacent cell eNB.

All of the abovementioned 11 methods optionally include that: when the source cell eNB is required to be off, the source cell eNB is still required to send the listening RS to the target cell eNB at the listening RS subframe position; and when the source cell eNB determines that it is not monitored by the target cell eNB, the source cell eNB is not required to continue sending the listening RS.

For example, when the target cell eNB is required to be off, the target cell eNB may send listening request information to the central node or the source cell eNB, the listening request information describing that the target cell eNB does not require the source cell eNB any longer through bit information. Since the target cell eNB is to be off, the target cell eNB sends listening request information to the source cell eNB, the listening request information describing that the target cell eNB does not require the source cell eNB any longer. The source cell eNB which receives the information is informed of not providing monitoring for air interface synchronization for the target cell eNB.

For example, the target cell eNB selects a suitable source cell eNB from multiple candidate source cell eNBs, and for the unselected candidate source cell eNBs, the target cell eNB sends source cell determination information and sets a bit meaning of the source cell determination information is that the cell eNBs which receive the source cell determination information are not selected as the source cell eNB.

All of the abovementioned 11 methods include that:

the central node includes a macro cell eNB and a core network element; and

interaction among the central node, the source cell, the target cell eNB, the adjacent cell eNB of the source cell and the adjacent cell eNB of the target cell may be implemented through the S1 interface, the X2 interface, the wireless air interface of the backhaul link.

Specific applications of the abovementioned methods will be described below through some specific embodiments.

### Embodiment 1

When a target cell eNB is initially deployed or the target cell eNB finds that a listening RS of a source cell eNB gets weak during operation, the target cell eNB sends listening request information to a central node, the listening request information including preliminary candidate source cell information obtained by the target cell eNB in a measurement manner. Here, the central node is supposed to be a macro cell eNB.

The central node selects a source cell eNB for the target cell eNB from candidate source cells reported by the target cell eNB, or the central node may also provide a source cell eNB from non-candidate source cells, and the central node sends information about the source cell eNB selected for the target cell eNB to the target cell eNB.

The central node simultaneously sends source information confirmation information to the selected source cell eNB to make the source cell eNB learn about that it is selected as the source cell eNB, and the central node is required to timely notify latest change information to the source cell eNB to make the source cell eNB always learn about whether it is being taken as the source cell eNB according to the reported information of the target cell eNB.

In such a manner, when the source cell eNB is required to be off, the source cell eNB may judge whether it is being taken as the source cell eNB, sends a listening RS if being taken as the source cell eNB, and is not required to send the listening RS when being off if having not been taken as the source cell eNB.

Whether the source cell eNB continues sending the listening RS when being off directly influences energy saving of the source cell eNB and air interface synchronization performance, and if the source eNB does not know whether it is being taken as the source cell eNB, once the source cell eNB stops sending the listening RS, air interface synchronization of the target cell eNB is directly influenced.

### Embodiment 2

When a target cell eNB is initially deployed or the target cell eNB finds that a listening RS of a source cell eNB gets weak during operation, the target cell eNB sends listening request information to candidate source cell eNBs, the listening request information including preliminary candidate source cell information obtained by the target cell eNB in a measurement manner.

The candidate source cell eNBs send request responses to a target cell, wherein the request responses may contain multiple of listening RS subframe position information, layer numbers, RS configuration information and a synchronization state of a source cell eNB, and the synchronization state is configured to describe whether a source cell is a synchronization source.

Then, the target cell eNB may rapidly receive listening RSs of the candidate source cell eNBs according to the information in the request responses, or rapidly and directly judge whether to continue taking it as a source cell eNB according to the layer number or the synchronization state after acquiring the request responses of the candidate source cell eNBs. Finally, the target cell eNB sends source cell determination information to the selected source cell eNB. If the target cell eNB does not select a suitable source cell eNB, the target cell eNB recollects candidate source cell eNBs and restarts the abovementioned process.

Wherein, the target cell eNB selects the proper source cell eNB according to the request responses, and then may also not send the source cell determination information to the selected source cell eNB. Then, the source cell eNB which sends the request response is required to consider that it has been selected as a source cell eNB of a certain cell. Such a manner is not so reasonable, but may also be adopted.

### Embodiment 3

When a target cell eNB is initially deployed or the target cell eNB finds that a listening RS of a source cell gets weak during operation, the target cell eNB sends listening request information to a central node (such as a network element of a core network), the listening request information including preliminary candidate source cell information obtained by the target cell eNB in a measurement manner.

The central node acquires related information of candidate source cells, and sends the related information to the target cell eNB, wherein the related information includes listening RS subframe position information, a layer number, RS configuration information and a synchronization state.

The target cell eNB selects a proper source cell eNB according to the related information, and sends source cell determination information to the central node.

The central node sends the source cell determination information to the source cell eNB selected by a target cell.

### Embodiment 4

When a target cell eNB is initially deployed or the target cell eNB finds that a listening RS of a source cell gets weak during operation, the target cell eNB sends listening request information to a central node (such as a network element of a core network), the listening request information including preliminary candidate source cell information obtained by the target cell eNB in a measurement manner.

The central node acquires related information of candidate source cells, and sends the related information to the target cell eNB, wherein the related information includes: listening RS subframe position information, a layer number, RS configuration information and a synchronization state.

The target cell eNB selects a proper source cell eNB according to the related information, and sends source cell determination information to the selected source cell eNB.

In order to implement the abovementioned methods, the embodiment of the disclosure further provides an air interface synchronization system, which may be structured as follows.

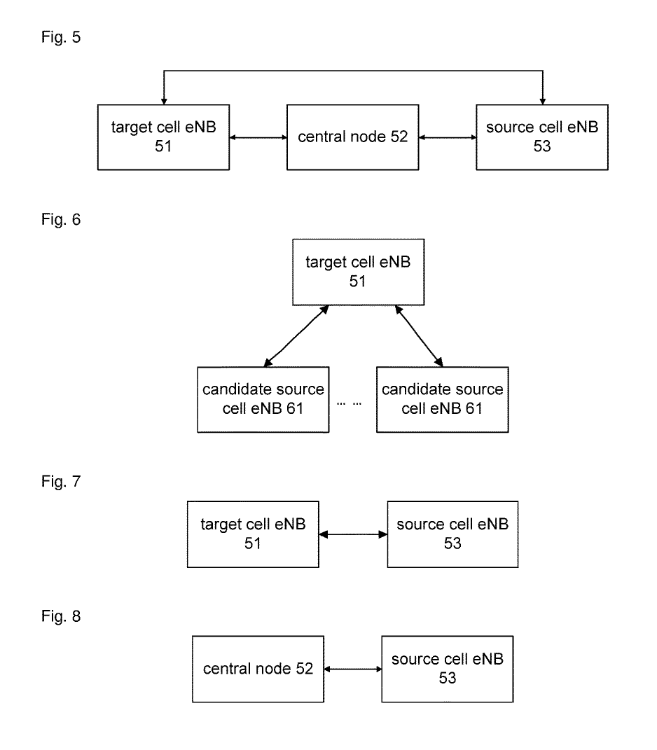

First: as shown in FIG. 5, the system includes: a target cell eNB 51, a central node 52 and a source cell eNB 53, wherein

the target cell eNB 51 sends listening request information containing candidate source cell information to the central node 52, and receives listening source cell information and listening RS subframe position information;

the central node 52 determines an air interface synchronization monitoring relationship according to the candidate source cell information, sends source cell determination information and the listening RS subframe position information to the source cell eNB 53 determined according to the air interface synchronization monitoring relationship, and sends the listening source cell information and the listening RS subframe position information to the target cell eNB 51; and

the source cell eNB 53 receives the source cell determination information and the listening RS subframe position information.

Here, the central node 52 includes a macro cell eNB and a network element of a core network; and

when the central node 52 interacts with the source cell eNB 53 or the target cell eNB 51, interaction is implemented through an S1 interface, or an X2 interface, or a wireless air interface or a backhaul link.

Second: as shown in FIG. 6, the system includes: a target cell eNB 51 and candidate source cell eNBs 61, wherein

the target cell eNB 51 sends listening request information for air interface synchronization to the candidate source cell eNBs 61, and selects a source cell eNB according to request responses of the candidate source cell eNBs; and

the candidate source cell eNBs 61 receive the listening request information and send the request responses to the target cell eNB 51, wherein the request responses includes one or more of: listening RS subframe position information, layer numbers and RS configuration information.

The target cell eNB 51 is further configured to send source cell determination information to the selected source cell eNB after selecting the source cell eNB according to the request responses.

Here, the candidate source cell eNBs 61 interact with the target cell eNB 51 through an S1 interface, or an X2 interface, or a wireless air interface or a backhaul link.

Third: as shown in FIG. 5, the system includes: a target cell eNB 51, a central node 52 and a source cell eNB 53, wherein

the target cell eNB 51 sends listening request information containing candidate source cell information to the central node 52, and selects the source cell eNB 53 according to related information, sent by the central node 52, of candidate source cells; and

the central node 52 acquires the related information of the candidate source cells, and sends the related information to the target cell eNB 51, wherein the related information includes one or more of: listening RS subframe position information, a layer number and RS configuration information.

The target cell eNB 51 is further configured to send source cell determination information to the central node 52 after selecting the source cell eNB 53 according to the related information;

the central node 52 is further configured to send the source cell determination information to the source cell eNB 53 selected by the target cell eNB 51; and

the source cell eNB 53 receives the source cell determination information.

Here, the central node 52 includes a macro cell eNB and a network element of a core network; and the central node 52 interacts with the source cell eNB 53 or a target cell eNB 51 through an S1 interface, or an X2 interface, or a wireless air interface or a backhaul link.

Fourth: as shown in FIG. 5, the system includes: a target cell eNB 51, a central node 52 and a source cell eNB 53, wherein

the target cell eNB 51 sends listening request information containing candidate source cell information to the central node 52, and selects the source cell eNB 53 according to related information, sent by the central node 52, of candidate source cells; and

the central node 52 acquires the related information of the candidate source cells, and sends the related information to the target cell eNB 51, wherein the related information includes one or more of: listening RS subframe position information, a layer number and RS configuration information.

The target cell eNB 51 is further configured to send source cell determination information to the selected source cell eNB 53 after selecting the source cell eNB 53 according to the related information.

Here, the central node 52 includes a macro cell eNB and a network element of a core network; and

the target cell eNB 51 interacts with the source cell eNB 53 or the central node 52 through an S1 interface, or an X2 interface, or a wireless air interface or a backhaul link.

Fifth: as shown in FIG. 7, the system includes: a target cell eNB 51 and a source cell eNB 53, wherein

the target cell eNB 51 selects the source cell eNB 53, and sends source cell determination information and listening RS subframe position information to the selected source cell eNB 53; and

the source cell eNB 53 sends a listening RS at a listening RS subframe position.

Here, the source cell eNB 53 interacts with the target cell eNB 51 through an S1 interface, or an X2 interface, or a wireless air interface or a backhaul link.

Sixth: as shown in FIG. 8, the system includes: a central node 52 and a source cell eNB 53, wherein

the central node 52 sends source cell determination information and listening RS subframe position information to the source cell eNB 53 of a cell selected as a source cell; and

the source cell eNB 53 sends a listening RS at a listening RS subframe position according to the listening RS subframe position information.

Here, the central node 52 includes a macro cell eNB and a network element of a core network; and

the central node 52 interacts with the source cell eNB 53 through an S1 interface, or an X2 interface, or a wireless air interface or a backhaul link.

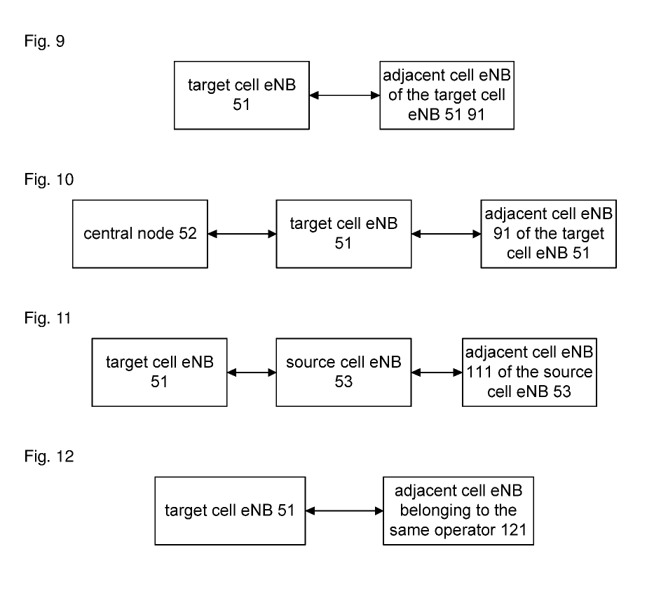

Seventh: as shown in FIG. 9, the system includes: a target cell eNB 51 and an adjacent cell eNB 91 of the target cell eNB 51, wherein

the target cell eNB 51 obtains a listening RS subframe position, sends listening RS subframe position information to the adjacent cell eNB 91, and indicates the adjacent cell eNB 91 to execute muting at the listening RS subframe position; and

in an embodiment, the target cell eNB 51 is specifically configured to receive the listening RS subframe position sent by a central node or request responses which are sent by candidate source cell eNBs and contain listening RS subframe position information, layer numbers and RS configuration information.

In an embodiment, the target cell eNB 51 is specifically configured to send the listening RS subframe position information to the adjacent cell eNB 91 through an S1 interface, or an X2 interface, or a wireless air interface or a backhaul link, and indicate, through identification information or a command message, the adjacent cell eNB 91 to execute muting at the listening RS subframe position.

In an embodiment, the target cell eNB 51 is specifically configured to send the listening RS subframe position information to the adjacent cell eNB 91 through the S1 interface, or the X2 interface, or the wireless air interface or the backhaul link.

In an embodiment, the target cell eNB 51 is specifically configured to send the identification information or the command message to the adjacent cell eNB 91 through the S1 interface, or the X2 interface, or the wireless air interface or the backhaul link; and

the adjacent cell eNB 91 is configured to execute muting at a listening RS subframe position or determine whether to execute muting at the listening RS subframe position according to own condition after receiving the listening RS subframe position information and the indication.

Here, the target cell eNB 51 is configured to describe the listening RS subframe position information through period information of a listening RS subframe and starting subframe position information of the listening RS subframe.

The listening RS subframe position information is information about a subframe position where the target cell eNB 51 monitors an RS.

Eighth: as shown in FIG. 10, the system includes: a central node 52, a target cell eNB 51 and an adjacent cell eNB 91 of the target cell eNB 51, wherein

the central node 52 determines a listening RS subframe position of a target cell, and sends listening RS subframe position information to the target cell eNB 51;

the target cell eNB 51 sends the listening RS subframe position information to the adjacent cell eNB 91 of the target cell eNB 51; and

the adjacent cell eNB 91 of the target cell eNB 51 receives the listening RS subframe position information.

Here, the central node 52 includes a macro cell eNB and a network element of a core network; and

the central node 52, the target cell eNB 51 and the adjacent cell eNB 91 of the target cell eNB 51 interact through an S1 interface, or an X2 interface, or a wireless air interface or a backhaul link.

Ninth: as shown in FIG. 10, the system includes: a central node 52, a target cell eNB 51 and an adjacent cell eNB 91 of the target cell eNB 51, wherein

the central node 52 determines a listening RS subframe position of a target cell, sends listening RS subframe position information to the target cell eNB 51 and the adjacent cell eNB 91 of the target cell eNB 51, and indicates the adjacent cell eNB 91 of the target cell eNB 51 to execute muting at the listening RS subframe position;

the target cell eNB 51 receives the listening RS subframe position information; and

the adjacent cell eNB 91 of the target cell eNB 51 receives the listening RS subframe position information and the indication.

Here, the central node 52 includes a macro cell eNB and a network element of a core network; and

the central node 52 interacts with the target cell eNB 51 and the adjacent cell eNB 91 of the target cell eNB 51 through an S1 interface, or an X2 interface, or a wireless air interface or a backhaul link.

Tenth: as shown in FIG. 11, the system includes: a target cell eNB 51, a source cell eNB 53 and an adjacent cell eNB 111 of the source cell eNB 53, wherein

the target cell eNB 51 selects the source cell eNB 53, and sends source cell determination information containing listening RS subframe position information to the selected source cell eNB 53;

the source cell eNB 53 receives the source cell determination information, and sends the listening RS subframe position information to own adjacent cell eNB 111; and

the adjacent cell eNB 111 of the source cell eNB 53 executes muting at a listening RS subframe position according to the listening RS subframe position information.

Here, when the target cell eNB 51, the source cell eNB 53 and the adjacent cell eNB 111 interact, interaction is implemented through an S1 interface, or an X2 interface, or a wireless air interface or a backhaul link.

Eleventh: as shown in FIG. 12, the system includes: a target cell eNB 51 and an adjacent cell eNB 121 belonging to the same operator, wherein

the target cell eNB 51 sends listening RS subframe position information to the adjacent cell eNB 121 belonging to the same operator, and indicates the adjacent cell eNB 121 belonging to the same operator to execute muting at a listening RS subframe position; and

the adjacent cell eNB 121 belonging to the same operator receives the listening RS subframe position information and the indication, and then the adjacent cell eNB 121 belonging to the same operator may immediately execute muting at the listening RS subframe position, and may also determines whether to execute muting at the listening RS subframe position according to own condition.

Here, when the target cell eNB 51 interacts with the adjacent cell eNB 121 belonging to the same operator, interaction is implemented through an S1 interface, or an X2 interface, or a wireless air interface or a backhaul link.

The indication may be identification information or a command message, for example: identification information 1 or 0 indicates execution of muting, or command message muting indicates execution of muting.

Wherein, the listening RS subframe position information is described through period information of a listening RS subframe and starting subframe position information of the listening RS subframe, and the listening RS subframe position information is information about a subframe position where the target cell eNB 51 monitors an RS.

The above is only the preferred embodiment of the disclosure, may be mixed for use under the condition of no conflicts among the embodiments, and is not intended to limit the scope of protection of the disclosure.

### INDUSTRIAL APPLICABILITY

According to the embodiments of the disclosure, a source cell may timely learn about whether it is selected as the source cell, so that the source cell may correctly send a listening RS when being off, and the problem that the source cell which may not learn about whether it is selected as the source cell by another cell may not judge whether to continue sending the listening RS when being off in an existing process is further solved.

1. An air interface synchronization method, comprising:
sending, by a target cell Evolved Node B (eNB), listening request information containing candidate source cell information to a central node; and
determining, by the central node, an air interface synchronization monitoring relationship according to the candidate source cell information, sending source cell determination information and listening Reference Signal (RS) subframe position information to a source cell eNB determined according to the air interface synchronization monitoring relationship, and sending listening source cell information and the listening RS subframe position information to the target cell eNB.

2. The method according to claim 1, wherein the central node comprises a macro cell eNB and a network element of a core network; and
when the central node interacts with the source cell eNB or the target cell eNB, interaction is implemented through an S1 interface, or an X2 interface, or a wireless air interface or a backhaul link.

3. The method according to claim 1, wherein
the listening RS subframe position information is configured to describe a subframe position for sending, monitoring and muting;
the source cell determination information is configured to notify a cell that it is selected as a source cell;
the listening request information is configured to indicate that a target cell is required to seek for a proper source cell; and
the candidate source cell information is cell information of a source cell capable of serving as a source cell of the target cell.

4-21. (canceled)

22. An air interface synchronization method, comprising:
obtaining, by a target cell Evolved Node B (eNB), a listening Reference Signal (RS) subframe position, sending listening RS subframe position information to an adjacent cell eNB, and indicating the adjacent cell eNB to execute muting at the listening RS subframe position.

23. The method according to claim 22, wherein obtaining, by the target cell eNB, the listening RS subframe position comprises:
receiving, by the target cell eNB, the listening RS subframe position sent by a central node or request responses which are sent by candidate source cell eNBs and contain the listening RS subframe position information, layer numbers and RS configuration information.

24. The method according to claim 22, wherein sending the listening RS subframe position information to the adjacent cell eNB and indicating the adjacent cell eNB to execute muting at the listening RS subframe position comprises: sending the listening RS subframe position information to the adjacent cell eNB through an S1 interface, or an X2 interface, or a wireless air interface or a backhaul link, and indicating, through identification information or a command message, the adjacent cell eNB to execute muting at the listening RS subframe position.

25. The method according to claim 22, wherein sending the listening RS subframe position information to the adjacent cell eNB and indicating the adjacent cell eNB to execute muting at the listening RS subframe position comprises: sending the listening RS subframe position information to the adjacent cell eNB through the S1 interface, or the X2 interface, or the wireless air interface or the backhaul link, and after the adjacent cell eNB receives the listening RS subframe position information and the indication, executing, by the adjacent cell eNB, muting at the listening RS subframe position, or determining, by the adjacent cell eNB, whether to execute muting at the listening RS subframe position according to own condition.

26. The method according to claim 22, wherein the listening RS subframe position information is described through period information of a listening RS subframe and starting subframe position information of the listening RS subframe.

27. The method according to claim 22, wherein the listening RS subframe position information is information about a subframe position where the target cell eNB monitors an RS.

28. The method according to claim 24, wherein the identification information or the command message is sent to the adjacent cell eNB through the S1 interface, or the X2 interface, or the wireless air interface or the backhaul link.

29-56. (canceled)

57. An air interface synchronization system, comprising: a target cell Evolved Node B (eNB) and an adjacent cell eNB,
wherein the target cell eNB is configured to obtain a listening Reference Signal (RS) subframe position, send listening RS subframe position information to the adjacent cell eNB, and indicate the adjacent cell eNB to execute muting at the listening RS subframe position.

58. The system according to claim 57, wherein the target cell eNB is configured to receive the listening RS subframe position sent by a central node or request responses which are sent by candidate source cell eNBs and contain the listening RS subframe position information, layer numbers and RS configuration information.

59. The system according to claim 57, wherein the target cell eNB is configured to send the listening RS subframe position information to the adjacent cell eNB through an S1 interface, or an X2 interface, or a wireless air interface or a backhaul link, and indicate, through identification information or a command message, the adjacent cell eNB to execute muting at the listening RS subframe position.

60. The system according to claim 57, wherein the target cell eNB is configured to send the listening RS subframe position information to the adjacent cell eNB through the S1 interface, or the X2 interface, or the wireless air interface or the backhaul link; and
the adjacent cell eNB is configured to, after receiving the listening RS subframe position information and the indication, execute muting at the listening RS subframe position, or determine whether to execute muting at the listening RS subframe position according to own condition.

61. The system according to claim 57, wherein the target cell eNB is configured to describe the listening RS subframe position information through period information of a listening RS subframe and starting subframe position information of the listening RS subframe.

62. The system according to claim 57, wherein the listening RS subframe position information is information about a subframe position where the target cell eNB monitors an RS.

63. The system according to claim 59, wherein the target cell eNB is configured to indicate, through the identification information or the command message, the adjacent cell eNB to execute muting at the listening RS subframe position, wherein the identification information or the command message is sent to the adjacent cell eNB through the S1 interface, or the X2 interface, or the wireless air interface or the backhaul link.

64-72. (canceled)

73. The method according to claim 26, wherein a starting subframe position indicated by the starting subframe position information is defined with respect to subframe 0 of radio frame 0.
